(19) United States
(12) Patent Application Publication
(10) Pub. No.: US 2004/0072548 A1
(43) Pub. Date: Apr. 15, 2004

(54) Transmission circuit suitable for dual-mode mobile phone

(76) Inventor: Jiro Kikuchi, Fukushima-ken (JP)

Correspondence Address: BRINKS HOFER GILSON & LIONE, P.O. BOX 10395, CHICAGO, IL, 60610, US

(21) Appl. No.: 10/622,014

(22) Filed: Jul. 16, 2003

(30) Foreign Application Priority Data
Jul. 16, 2002 (JP) 2002-206955

(51) Int. Cl. H04B 1/18; H04B 7/00

(52) U.S. Cl. 455/232.1; 455/234.1; 455/182.1

(57) ABSTRACT

A transmission circuit comprises the following: a power amplifier whose gain is controlled; a detector which detects a transmission signal from the power amplifier and outputs a detection voltage corresponding to a level of the signal; and a gain controller which compares a transmission power set voltage for setting the level of the transmission signal to be outputted from the power amplifier with the detection voltage and supplies a gain control voltage to the power amplifier. The transmission power set voltage is sent through a low pass filter into the gain controller.

### BACKGROUND OF THE INVENTION

1. Field of the Invention

The present invention relates to transmission circuits for use in such mobile phones as portable phones and car phones, and more particularly to transmission circuits suitable for dual-mode mobile phones which switch between communication modes such as CDMA, AMPS, and GSM to transmit signals.

2. Description of the Related Art

FIG. 3 shows a transmission circuit of a dual-mode portable phone which uses both the CDMA (Code Division Multiple Access) system and the AMPS (Advanced Mobile Phone Services) system, which are used in the U.S.A.

In this case, transmission data which is based on the CDMA or AMPS system enters a modulator 41. After a carrier wave from an oscillator 42 enters the modulator 41, it is modulated by the transmission data. Thus, the modulator 41 outputs a transmission signal which is based on the CDMA or AMPS system. This transmission signal is amplified by a front-end amplifier 43. The front-end amplifier 43 includes a variable gain amplifier.

The transmission signal outputted from the front-end amplifier 43 enters a first changeover switch 44. The first changeover switch 44 is intended to select either the CDMA mode or the AMPS mode. It includes a single-pole, a double-throw switch circuit or the like. From the switch 44, an AMPS transmission signal enters a first power amplifier 45 and a CDMA transmission signal enters a second power amplifier 46.

The first power amplifier 45 includes a variable gain amplifier which operates in Class C. Its gain is set according to a gain control voltage which is supplied by a gain controller 47. The gain controller 47 receives a transmission power set voltage (simply indicated as “SET VOLTAGE” in FIG. 3) which determines the level of the transmission signal to be outputted from the first power amplifier 45. The transmission power set voltage is generated according to a control signal which comes from a base station. The transmission signal from the first power amplifier 45 is detected and the voltage corresponding to the detected signal level also enters the gain controller 47. In other words, the transmission signal is sent to an antenna (not shown) and also detected by a detector 48.

The detector 48 incorporates a coupler 48a and a detector 48b and outputs a detection voltage corresponding to the detected signal level. The detection voltage is supplied to the gain controller 47. The gain controller 47 compares the detection voltage with the transmission power set voltage and supplies a gain control voltage based on the difference between them through a first open/close switch 49 to the first power amplifier 45. The first power amplifier 45 is thus controlled so that it outputs a transmission signal of the set level and also the signal level is constant. The first open/close switch 49 is controlled according to a power ON/OFF signal (ON/OFF SIGNAL in FIG. 3). The switch is turned ON for transmission and OFF for reception.

In the CDMA mode, the transmission power set voltage is supplied through a second changeover switch 50 to the front-end amplifier 43. In the AMPS mode, a fixed bias voltage which has been set by a first bias power supply 51 is supplied through a second changeover switch 50 to the front-end amplifier 43. The gain of the front-end amplifier 43 is thus set. The second changeover switch 50 works in conjunction with the first changeover switch 44.

Then, a fixed bias voltage which has been set by a second bias power supply 52 is applied through a second open/close switch 53 to a second power amplifier 46. The second power amplifier 46 is designed to operate in Class A. Thus, the gain of the second power amplifier 46 is constant. The second open/close switch 53 is also controlled according to the power ON/OFF signal. The switch is turned ON for transmission and OFF for reception. The power ON/OFF signal is supplied through a third changeover switch 54 to the first open/close switch 49 or the second open/close switch 53. The third changeover switch 54 also works in conjunction with the first changeover switch 44.

In the above constitution, in the AMPS mode the bias voltage set by the first bias power supply 51 is applied to the front-end amplifier 43 and the gain of the front-end amplifier 43 is constant. The transmission signal from the front-end amplifier 43 goes through the first changeover switch 44 to the first power amplifier 45. In transmission, the first open/close switch 49 is turned ON according to the power ON/OFF signal and a gain control voltage from the gain controller 47 is applied to the first power amplifier 45 to activate it. Thus activated, the first power amplifier 45 outputs a transmission signal of the level set by the transmission power set voltage. In reception, the first open/close switch 49 is turned OFF and the first power amplifier 45 is cut off and becomes inactive.

On the other hand, in the CDMA mode, the transmission power set voltage is applied to the front-end amplifier 43, which functions as a variable gain amplifier. The transmission signal from the front-end amplifier 43 is sent through the first changeover switch 44 to the second power amplifier 46. In transmission, the second open/close switch 53 is turned ON according to the power ON/OFF signal and a bias voltage from the second bias power supply 52 is applied to the second power amplifier 46 to activate it. Thus activated, the second power amplifier 46 outputs a transmission signal of the level set by the transmission power set voltage. In reception, the second open/close switch 53 is turned OFF and the second power amplifier 46 is cut off and becomes inactive.

In the above constitution, if the first power amplifier is turned ON and the transmission power set voltage is changed according to an instruction from a base station, the difference between the transmission power set voltage and the detection voltage will suddenly increase and the transmission power of the first power amplifier will sharply change with time; there will be some power fluctuation and overshoot until the transmission power reaches the set level and becomes stable. As the time to attain the set level is longer, temporary excessive power output is more likely to occur. In the worst case, the first power amplifier might be broken. In addition, output of excessive transmission power might cause interference with another receiver.

As indicated by curve A in FIG. 4, if the transmission power set voltage is changed at time T0 so as to set the transmission power to the maximum (36 dBm), the transmission power goes up beyond 36 dBM and peaks within 2 mS (milliseconds), which is the prescribed time for the transmission power to stabilize, and after the prescribed time of 2 mS elapses, it goes down to 36 dBm and becomes stable. Similarly, as indicated by curve B in FIG. 4, even if the transmission power set voltage is changed so as to set the transmission power to 8 dB, the transmission power curve follows the same track as that of curve A until the transmission power peaks; then, it goes down to 8 dB and becomes stable.

### SUMMARY OF THE INVENTION

An object of the present invention is to protect a power amplifier in a transmission circuit by preventing its output power from going beyond a set level even when a transmission power set voltage is changed. Another object of the invention is to prevent it from interfering with another receiver and shorten the time required for the transmission power to reach the set level and become stable.

According to one aspect of the present invention as a solution to the above problem, a transmission circuit comprises the following: a power amplifier whose gain is controlled; a detector which detects a transmission signal from the power amplifier and outputs a detection voltage corresponding to a level of the signal; and a gain controller which compares a transmission power set voltage for setting the level of the transmission signal to be outputted from the power amplifier with the detection voltage and supplies a gain control voltage to the power amplifier. The transmission power set voltage is sent through a low pass filter to the gain controller.

According to another aspect of the invention, the low pass filter includes an integration circuit.

According to another aspect of the invention, the transmission circuit has an open/close switch to activate or inactivate the power amplifier, and the transmission power set voltage is sent through the open/close switch to the low pass filter.

### BRIEF DESCRIPTION OF THE DRAWINGS

The invention will be more particularly described with reference to the accompanying drawings, in which:

FIG. 1 is a circuit diagram showing the structure of a transmission circuit according to the present invention;

FIG. 2 is a graph showing change in the transmission power of a power amplifier in the transmission circuit according to the present invention;

FIG. 3 is a circuit diagram showing the structure of a conventional transmission circuit; and

FIG. 4 is a graph showing change in the transmission power of a power amplifier in the conventional transmission circuit.

### DETAILED DESCRIPTION OF THE PREFERRED EMBODIMENTS

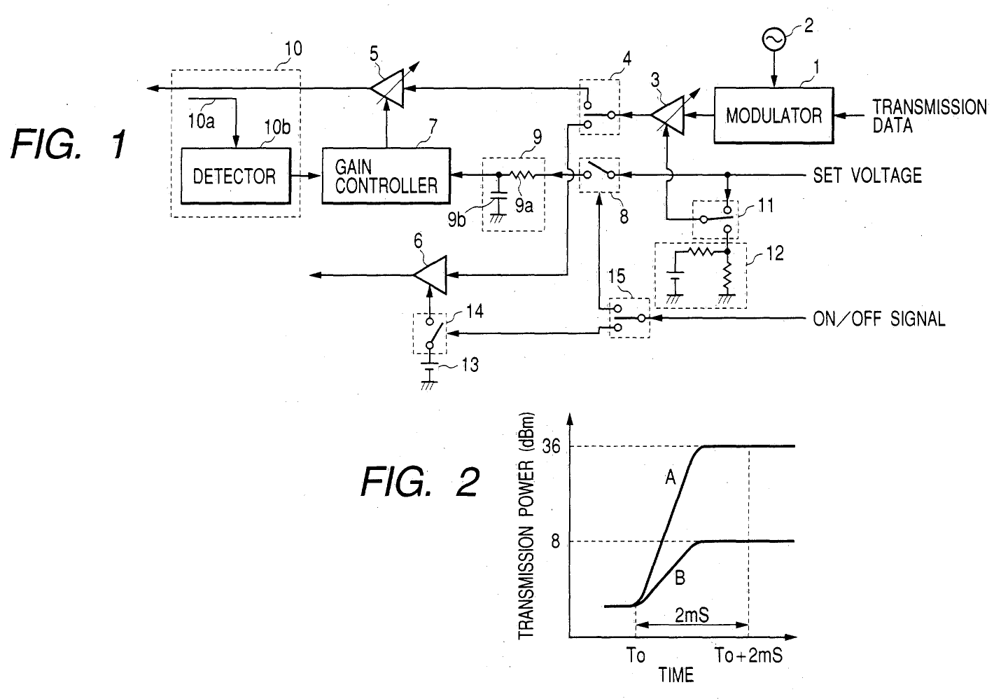

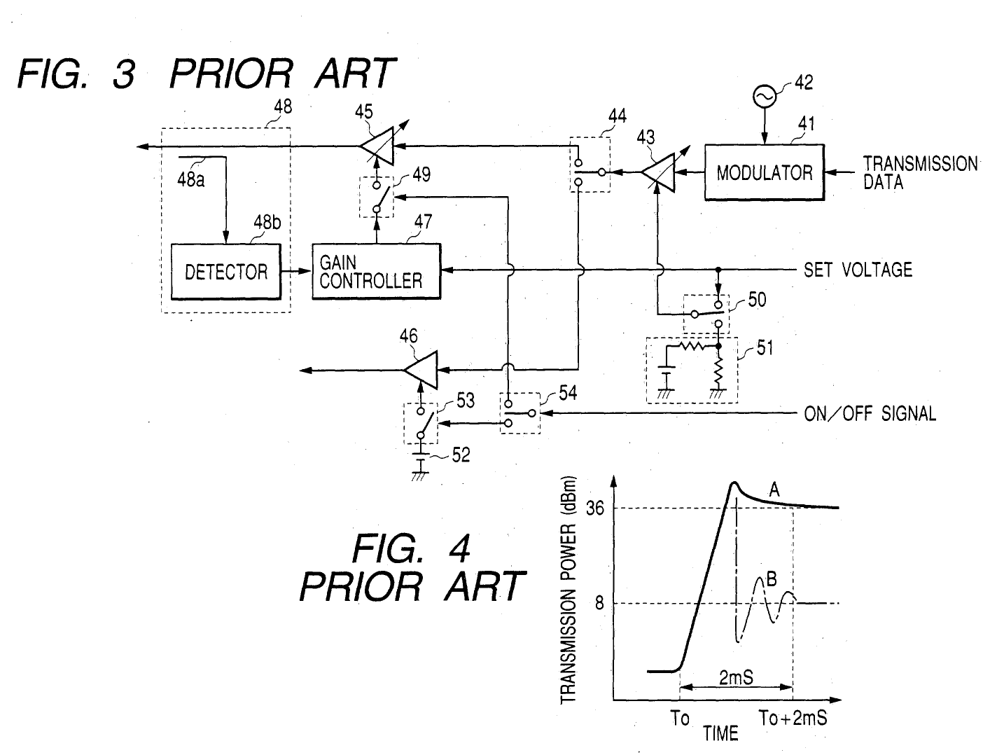

Next, a transmission circuit according to the present invention will be described referring to FIGS. 1 and 2. First, transmission data which is based on the CSMA or AMPS system enters a modulator 1 as illustrated in FIG. 1. A carrier wave from an oscillator 2 enters the modulator 1; then it is modulated by the transmission data. Thus, the modulator 1 outputs a transmission signal which is based on the CDMA or AMPS system. This transmission signal is amplified by a front-end amplifier 3. The front-end amplifier 3 includes a variable gain amplifier. It is used as a variable gain amplifier in the CDMA mode and as a fixed gain amplifier in the AMPS mode.

The transmission signal outputted from the front-end amplifier 3 enters a first changeover switch 4. The first changeover switch 4 is intended to select either the CDMA mode or the AMPS mode. It includes a single-pole, double-throw switch circuit or the like. From the switch 4, an AMPS transmission signal enters a first power amplifier 5 and a CDMA transmission signal enters a second power amplifier 6.

The first power amplifier 5 includes a variable gain amplifier which operates in Class C. Its gain is set according to a gain control voltage which is supplied by a gain controller 7. The gain controller 7 receives a transmission power set voltage (“SET VOLTAGE” in FIG. 1) which determines the level of the transmission signal (transmission power) to be outputted from the first power amplifier 5. The voltage is sent to the gain controller 7 through a first open/close switch 8 and a low pass filter 9 which are connected in series. The first open/close switch 8 is turned ON to activate the first power amplifier 5 and OFF to inactivate it. It is desirable that the low pass filter 9 be an integration circuit with a resistor 9a on the input side and a capacitor 9b on the output side.

The transmission power set voltage is generated according to a control signal which comes from a base station. In the AMPS system, eight levels of transmission power are available. The transmission signal from the first power amplifier 5 is sent to an antenna (not shown) and also detected by a detector 10.

The detector 10 incorporates a coupler 10a and a detector 10b and outputs a detection voltage corresponding to the detected signal level. The detection voltage is supplied to the gain controller 7 and compared with the transmission power set signal. The gain controller 7 compares the detection voltage with the transmission power set voltage and supplies a gain control voltage based on the difference between them to the first power amplifier 5. The first power amplifier 5 is thus controlled so that it outputs a transmission signal of the set level and the signal level is constant. The first open/close switch 8 is controlled according to a power ON/OFF signal. The switch is turned ON for transmission and OFF for reception.

In the CDMA mode, the transmission power set voltage is supplied through a second changeover switch 11 to the front-end amplifier 3. In the AMPS mode, a fixed bias voltage which has been set by a first bias power supply 12 is supplied through a second changeover switch 11 to the front-end amplifier 3. The gain of the front-end amplifier 3 is thus set. The second changeover switch 11 works in conjunction with the first changeover switch 4.

Then, a fixed bias voltage which has been set by a second bias power supply 13 is applied through a second open/close switch 14 to a second power amplifier 6. The second power amplifier 6 is designed to operate in Class A. Thus, the gain of the second power amplifier 6 is constant. The second open/close switch 14 is also controlled according to the power ON/OFF signal. The switch is turned ON for transmission and OFF for reception. The power ON/OFF signal is supplied through a third changeover switch 15 to the first open/close switch 8 or the second open/close switch 14. The third changeover switch 15 also works in conjunction with the first changeover switch 4.

In the above constitution, in the AMPS mode the bias voltage set by the first bias power supply 12 is applied to the front-end amplifier 3 and the gain of the front-end amplifier 3 is constant. The transmission signal from the front-end amplifier 3 goes through the first changeover switch 4 to the first power amplifier 5. In transmission, the first open/close switch 8 is turned ON according to the power ON/OFF signal and a control voltage from the gain controller 7 is applied to the first power amplifier 5 to activate it. Thus activated, the first power amplifier 5 outputs a transmission signal of the level set by the transmission power set voltage.

An explanation is given below concerning how the circuit operates when the transmission power set signal (voltage) is changed. Let's assume that at time T0 the transmission power set voltage is changed to a new one to increase the transmission power, for example, to 36 dBm. This new set voltage is supplied through the low pass filter 9 to the gain controller 7, so the set voltage supplied to the gain controller 7 gradually rises. During this process, it is compared with the detection voltage, so change in the level of the transmission signal outputted from the first power amplifier 5 is gradual as indicated by curve A in FIG. 2. Here, no fluctuation or overshoot is observed and the time required for the transmission power to reach the set level is shortened. Needless to say, the time constant for the low pass filter 9 must be selected in a way to reach the required set voltage within the prescribed time (2 mS) completely. When the low pass filter 9 includes an integration circuit, it is easy to set the time constant. In addition, the voltage change caused by action of the first open/close switch 8 is once filtered by the low pass filter 9 and sent to the gain controller 7.

Similarly, even if the transmission power set voltage is changed so as to set the transmission power to 8 dBm, the set voltage gradually rises and the transmission signal level changes more gradually as indicated by curve B in FIG. 2. Again, no fluctuation or overshoot is observed and the time required for the transmission power to reach the set level is shortened. Therefore, no excessive level signal will be outputted from the first power amplifier 5.

In reception, the first open/close switch 8 is turned OFF and the first power amplifier 5 is cut off and becomes inactive.

On the other hand, in the CDMA mode, the transmission power set voltage is applied to the front-end amplifier 3, which functions as a variable gain amplifier. The transmission signal from the front-end amplifier 3 is sent through the first changeover switch 4 to the second power amplifier 6. In transmission, the second open/close switch 14 is turned ON according to the power ON/OFF signal and a bias voltage from the second bias power supply 13 is applied to the second power amplifier 6 to activate it. Thus activated, the second power amplifier 6 outputs a transmission signal of the level set by the transmission power set voltage. In reception, the second open/close switch 14 is turned OFF and the second power amplifier 6 is cut off and becomes inactive.

The present invention may be applied not only to a transmission circuit used in a dual-mode mobile phone. Obviously, it may also be applied to a transmission circuit of a mobile phone which uses only the AMPS mode.

As discussed so far, the transmission circuit according to the present invention incorporates a gain controller which compares the transmission power set voltage for setting the level of a transmission signal to be outputted from a power amplifier with a detection voltage and also supplies a gain control voltage to the power amplifier. Since the transmission power set voltage is sent through a low pass filter to the gain controller, the set voltage actually supplied to the gain controller gradually rises. During this process, it is compared with the detection voltage, so change in the level of the transmission signal outputted from the first power amplifier is gradual and no fluctuation nor overshoot is observed and the time required for the transmission power to reach the set level is shortened. Therefore, no excessive level transmission signal will be outputted and the power amplifier can not be broken. Furthermore, the transmission signal cannot interfere with another receiver.

Since the low pass filter includes an integration circuit, its structure is simple and the time constant for it can be easily set.

The circuit also has an open/close switch to activate or inactivate the power amplifier. The transmission power set voltage is sent through the open/close switch to the low pass filter. A voltage change caused by turning on/off of the open/close switch is filtered by the low pass filter so that it does not affect the gain control voltage.

What is claimed is:

1. A transmission circuit comprising:
a power amplifier whose gain is controlled;
a detector which detects a transmission signal from the power amplifier and outputs a detection voltage corresponding to a level of the signal; and
a gain controller which compares a transmission power set voltage for setting the level of the transmission signal to be outputted from the power amplifier with the detection voltage and supplies a gain control voltage to the power amplifier, wherein the transmission power set voltage is sent through a low pass filter to the gain controller.

2. The transmission circuit according to claim 1, wherein the low pass filter includes an integration circuit.

3. The transmission circuit according to claim 1, wherein there is an open/close switch to activate or inactivate the power amplifier, and wherein the transmission power set voltage is sent through the open/close switch to the low pass filter.
